(19) United States
(12) Patent Application Publication
(10) Pub. No.: US 2026/0132967 A1
(43) Pub. Date: May 14, 2026

(54) Absorption Induced Caloric Effects and Uses Thereof

(71) Applicant: Cambridge Enterprise Limited, Cambridge, Cambridgeshire (GB)

(72) Inventors: Melony Dilshad, Cambridge, Cambridgeshire (GB); Enric Stern-Taulats, Cambridge, Cambridgeshire (GB); Javier Eduardo Moya Raposo, Cambridge, Cambridgeshire (GB)

(21) Appl. No.: 19/115,426

(22) PCT Filed: Sep. 30, 2022
(86) PCT No.: PCT/EP2022/077404

§ 371 Date: Mar. 26, 2025

(51) Int. Cl. F25B 17/08; B01J 20/22; C09K 5/04

(52) U.S. Cl. CPC F25B 17/08; B01J 20/226; C09K 5/047

(57) ABSTRACT

The present invention relates to use of a fluid to drive a phase transition induced by absorption/desorption of the fluid into and out of the caloric material. A method is providing in which a sorptiocaloric material is contacted with a fluid such that the fluid is absorbed into and at least partially throughout the sorptiocaloric material to induce a phase transition and heat is permitted to flow to or from the sorptiocaloric material. The fluid is then released and is desorbed out of the sorptiocaloric material to induce the reverse phase transition and reverse heat flow. The sorptiocaloric phase transition is capable of very large latent heats under ambient conditions making it potentially useful in conventional cooling and heating applications as well as thermal storage.

### TECHNICAL FIELD

This invention relates to methods of caloric cooling or heating and in particular to such methods and materials that exhibit caloric effects induced by absorption and desorption of a fluid into the material. The invention also relates to a cooling or heating apparatus and use of such caloric materials for cooling or heating applications. Such use may be in continuous heating and cooling cycles (e.g. in refrigeration) or in thermal storage devices (e.g. transport of heat from a location where excess heat is produced such as a power plant to a location where heat is needed such as an industrial plant.)

The project leading to this application has received funding from the European Research Council (ERC) under the European Union's Horizon 2020 research and innovation programme (grant agreement No 680032).

### BACKGROUND

Magnetocaloric, electrocaloric and mechanocaloric effects are nominally reversible thermal changes that occur in magnetically, electrically and mechanically responsive materials when subjected to changes in magnetic, electric and mechanical applied fields, respectively. Mechanocaloric effects can be subdivided into those driven by uniaxial stress (elastocaloric effects) and those driven by hydrostatic pressure (barocaloric effects). These effects, which are largest near phase transitions, are analogous to the pressure-induced thermal changes in fluids that are exploited in most current heating and cooling systems. Importantly, these caloric effects promise higher energy efficiencies and obviate the need for ozone depleting or greenhouse gases.

Development of new heating or cooling technologies based on caloric effects, therefore, may ease issues around energy consumption and protect the environment. In order to harness this possibility, suitable transitions (e.g. in terms of magnitude and conditions required) and materials are needed. For example, an alternative cooling or heating effect will need a large (giant) and fully reversible thermal change ideally in response to small and inexpensive applied fields. Even more preferably this change will occur near room temperature for ease of implementation as well as for environmental impact reasons.

Magneto-, electro- and elasto-caloric materials have been widely studied with the aim of providing environmentally friendly heating and cooling applications. In some cases, relatively big thermal changes have been found. However, to date magnetocaloric materials typically require the use of large magnetic fields that are expensive permanent magnets to generate large magnetic fields. In general, this is less easy to implement as well as potentially requiring more energy making them less environmentally friendly. Similarly, electrocaloric and elastocaloric materials found to date typically require the use of large electric fields or large mechanical stresses that often lead to electrical and mechanical breakdown, and ultimately failure. These problems might explain why heating and cooling technologies based on magnetocaloric, electrocaloric, and elastocaloric materials have not yet reached the market, despite decades of research.

More recently, barocaloric materials have also been disclosed such as in WO2018/069506. Barocaloric materials exhibit caloric effects that are driven by large pressure changes on the material.

There is a need to identify materials exhibiting large caloric effects, particularly where a reversible phase transition occurs near ambient temperatures and in response to small and inexpensive stimuli. It is an aim of the invention to solve one or more of the problems discussed above.

### SUMMARY OF THE INVENTION

The present invention relates to use of a fluid to drive a phase transition in a caloric material for cooling or heating. The phase transition is induced by absorption/desorption of the fluid into and out of the caloric material. This type of caloric effect may be referred to as a sorptiocaloric effect and caloric materials exhibiting such effects may be referred to as sorptiocaloric materials.

In a first aspect there is provided a method of caloric cooling or heating, the method comprising the steps of:
(i) providing a sorptiocaloric material;
(ii) contacting the sorptiocaloric material with a fluid such that the fluid is absorbed into and at least partially throughout the sorptiocaloric material to induce a phase transition;
(iii) permitting heat flow from or to the sorptiocaloric material;
(iv) releasing the fluid such that the fluid is desorbed out of the sorptiocaloric material and the reverse phase transition is induced; and
(v) permitting heat flow to or from the sorptiocaloric material.

In the method the sorptiocaloric material undergoes a fluid-driven phase transition based on a new caloric effect that is distinct from magnetocaloric, electrocaloric, elastocaloric and barocaloric effects that have previously been described.

The phase transition of the sorptiocaloric material in the present invention is a reversible transition between a first state in which the fluid is not absorbed into and throughout the sorptiocaloric material and a second state in which the fluid is absorbed into and throughout the sorptiocaloric material. The phrase “absorbed into and throughout the sorptiocaloric material” refers to the case where fluid is present not only on the surface layer of the sorptiocaloric material but where fluid is absorbed throughout the whole of the 3-dimensional structure of the sorptiocaloric material, such as in pores within the internal structure of the sorptiocaloric material.

The fluid may form an intermolecular interaction with the sorptiocaloric material. The phase transition is induced by absorption/desorption of the fluid on the sorptiocaloric material (“sorptiocaloric”). The sorptiocaloric phase transition in the present case may be a first order phase transition.

The sorptiocaloric phase transition is capable of very large latent heats and volume changes. It is proposed that this is the result of structural or conformational phase transitions driven by the absorption of the fluid.

In this way, the sorptiocaloric process, use and apparatus described herein can provide improved caloric effects compared to known systems. Further advantageously, the sorptiocaloric phase transition can be achieved at low pressure and may also be achieved around ambient temperature making them particularly useful for heating or cooling applications and for thermal energy storage.

Preferably, a phase transition in the sorptiocaloric material displays a latent heat, |Q₀|, that is 10 kJ kg⁻¹ or more, such as 25 kJ kg⁻¹ or more, such as 50 kJ kg⁻¹ or more, such as 100 kJ kg⁻¹ or more, such as 250 kJ kg⁻¹ or more, such as 500 kJ kg⁻¹ or more.

Preferably, the sorptiocaloric material has an entropy change at a phase transition, |ΔS₀|, of 5 J K⁻¹ kg⁻¹ or more, such as 10 J K⁻¹ kg⁻¹ or more, such as 15 J K⁻¹ kg⁻¹ or more, such as 20 J K⁻¹ kg⁻¹ or more, such as 25 J K⁻¹ kg⁻¹ or more, such as 50 J K⁻¹ kg⁻¹ or more, such as 75 J K⁻¹ kg⁻¹ or more, such as 100 J K⁻¹ kg⁻¹ or more, such as 150 J K⁻¹ kg⁻¹ or more, such as 200 J K⁻¹ kg⁻¹ or more.

The sorptiocaloric material may have a phase transition at a temperature within the range of 10 K to 500 K such as 50 K to 500K, preferably from 200 K to 450 K, such as 250 K to 350 K, such as 280 K to 340 K. These sorptiocaloric materials are particularly suitable for use under ambient conditions.

Preferably, the phase transition of the sorptiocaloric material is a first-order phase transition. The phase transition may be a first-order structural phase transition, such as between symmetry groups.

The sorptiocaloric material may be contacted with the fluid at a pressure of 500 MPa or less, such as 200 MPa or less, such as 100 MPa or less, such as 50 MPa or less, such as 25 MPa or less, such as 20 MPa or less, such as 10 MPa or less, such as 5 MPa or less, such as 1 MPa or less. The pressure may be relatively low, such as compared to methods using mechanocaloric materials which may typically be driven at hydrostatic pressures of 100 MPa or more.

In a second aspect, there is provided a cooling or heating apparatus comprising
a sorptiocaloric material as a cooling or heating agent;
a means for transferring heat to and from the sorptiocaloric material; and
a means for reversibly contacting the sorptiocaloric material with a fluid such that the fluid is absorbed into and throughout the sorptiocaloric material to induce a phase transition.

The cooling or heating apparatus may comprise means for applying hydrostatic pressure or means for transferring heat to the sorptiocaloric material.

Preferred features of the first aspect apply equally to the second aspect.

In a third aspect, there is provided a use of a sorptiocaloric material as a cooling or heating material, wherein the use comprises contacting the sorptiocaloric material with a fluid such that the fluid is absorbed into and throughout the sorptiocaloric material to induce a phase transition.

Preferred features of the first aspect apply equally to the third aspect.

### SUMMARY OF THE FIGURES

The present invention is described with reference to the figures listed below.

FIG. 1 shows the ambient-pressure calorimetric analysis of MIL-53(Fe). Panel (a) shows dQ/|dT| in MIL-53(Fe) on heating (red) and cooling (blue) and panel (b) shows corresponding thermally driven entropy change near the dehydration/hydration transition in MIL 53(Fe) with respect to the low temperature (hydrated) phase.

FIG. 2 shows the calorimetric analysis of the dehydration/hydration-induced structural transition in MIL-53(Fe). Panel (a) isobaric dQ/|dT| measurements. Panel (c) shows transition temperatures for the transition as a function of pressure p on cooling and heating with linear lines of fit for the overall data set.

FIG. 3 shows sorptiocaloric effects in MIL-53(Fe) near its dehydration/hydration induced transition. Panel (a) shows isothermal ΔSᵢₜ(T) driven by absorption of water (applying pressure 0→p) or desorption of water (removing pressure p→0).

### DETAILED DESCRIPTION OF THE INVENTION

In a general aspect, the present invention relates to use of a fluid to drive a phase transition in a caloric material for cooling or heating. The phase transition is induced by absorption/desorption of the fluid.

Caloric effects that are driven by magnetic, electric or mechanical applied fields are known. However, magnetocaloric, electrocaloric, and mechanocaloric materials are associated with drawbacks.

The inventors have now established that phase transitions driven by absorption and desorption of a fluid in materials can provide large caloric effects. This new caloric effect can be used as an alternative to magnetocaloric, electrocaloric, and mechanocaloric effects previously described.

Boldrin describes “breathing transitions” that are observed for ZIF materials, and described the use of zeolites as energy storage materials. Boldrin suggests that ZIF materials can be excellent barocaloric candidates. However, Boldrin reports that many materials in the ZIF subfamily have transitions that are irreversible. ZIF-4(Zn) is reported to have a reversible transition at a temperature of 140 K making the particular transition disclosed in Boldrin unsuitable for typical cooling and heating applications near room temperature.

In the present invention reversible transitions in sorptiocaloric materials using absorption/desorption of fluids such as benign gases and liquids are provided. These new sorptiocaloric effects and materials represent a paradigm shift for caloric heating and cooling, and have the ability to provide giant thermal changes associated with room-temperature structural phase transitions, such as in hybrid organic-inorganic materials, to be driven environmentally friendly, efficiently and inexpensively.

Specifically, in a first aspect there is provided a method of caloric cooling or heating, the method comprising the steps of:
(i) providing a sorptiocaloric material;
(ii) contacting the sorptiocaloric material with a fluid such that the fluid is absorbed into and at least partially throughout the sorptiocaloric material to induce a phase transition;
(iii) permitting heat flow from or to the sorptiocaloric material;
(iv) releasing the fluid such that the fluid is desorbed out of the sorptiocaloric material and the reverse phase transition is induced; and
(v) permitting heat flow to or from the sorptiocaloric material.

In some embodiment, the fluid is absorbed into and substantially entirely throughout the sorptiocaloric material to induce the phase transition. In other embodiments, the fluid is absorbed into and in only a portion throughout the sorptiocaloric material and this is sufficient to induce a phase transition.

A reversible phase transition is induced by contacting the sorptiocaloric material with the fluid such that the fluid is absorbed by the sorptiocaloric material. The fluid may chemically interact with the sorptiocaloric material. Preferably, the fluid forms one or more intermolecular bonds with the sorptiocaloric material, such as one or more hydrogen bonds.

The phase transition in the present case is distinct from a barocaloric transition induced by a change in pressure, where a pressure-transmitting fluid may be used. In the methods of the present invention the fluid interacts with and is absorbed by the sorptiocaloric material, for example to form intermolecular bonds, and this absorption promotes a phase transition.

The sorptiocaloric phase transitions of the invention can exhibit large latent heats and volume changes. In this way, the invention may provide improved caloric effects compared to known magnetocaloric, electrocaloric or mechanocaloric materials, and may provide performance that matches applications needs. For example, the latent heat associated with the transitions (and process, use and apparatus) described herein may typically be around 50 kJ kg⁻¹, under very low pressures of around 10 bar. In comparison, for mechanocaloric materials typical latent heat values may be around 10 kJ kg⁻¹ which is driven by changes in hydrostatic pressure of around 2,000 bar.

In this way, the invention provides a heating or cooling process with large thermal changes at room temperature and low pressures that are reversibly driven using a fluid.

The use of the term “absorption” herein requires the fluid to be contained internally within (and throughout) the 3-dimensional structure of the sorptiocaloric material (i.e. in line with the normal meaning of absorption). For example, a porous sorptiocaloric material, such as an open-framework material may comprise pores internally within the material. Absorption of a fluid may comprise occupation of the pores within the porous sorptiocaloric material. Absorption may comprise the formation or breaking of chemical bonds or Van der Waals interactions between the fluid and the sorptiocaloric material such as the formation of a host-guest interaction of the fluid within a pore of a porous sorptiocaloric material.

When used herein, absorption also includes and allows the fluid to be adsorbed onto a surface, including external surfaces, of the sorptiocaloric material. That is, it is possible that surface adsorption occurs in the process of the invention so long as the fluid is absorbed within the sorptiocaloric material.

Desorption of the fluid from the sorptiocaloric material comprises release of a fluid that is absorbed within the sorptiocaloric material. Desorption may comprise breaking a host-guest interaction between the fluid and the sorptiocaloric material. Once desorbed, the fluid may surround the sorptiocaloric material or may be no longer in contact with the sorptiocaloric material.

In some embodiments, the phase change is a structural or conformational phase change, preferably a structural change. In some cases, the phase change may be a first-order structural phase transitions or first-order conformational phase transitions.

The fluid (used to drive the phase transition) may be an inert fluid. Preferably, the fluid is nitrogen gas, CO₂, C₁₋₆ alkane or water, more preferably the fluid is water.

A C₁₋₆ alkane may be a C₁₋₄ alkane, such as methane or ethane, preferably methane.

Such fluids are typically cheap and abundant making them particularly suitable for use in cooling and heating applications.

In some embodiments, the sorptiocaloric material is MIL-53(AI). Preferably, the sorptiocaloric material is not MIL-53(AI).

### Sorptiocaloric Materials

The sorptiocaloric materials used in the method, use and apparatus of the invention are materials which exhibit caloric effects in response to absorption/desorption the fluid from the material.

Without wishing to be bound by theory, it is thought that absorption and desorption of the fluid from the sorptiocaloric material results in the formation and breaking of bonding interactions between the sorptiocaloric material and the fluid. This results in changes in the total energy of the system and leads to a phase transition accompanied by caloric effects. The fluid may be absorbed as a guest in the host network of the sorptiocaloric material. The absorption and desorption of the fluid may also result in changes in volume but it is thought that the bonding interactions are the driving mechanism for the phase transition and caloric effects.

In the methods, use and apparatus described herein a sorptiocaloric material is contacted with a fluid and the fluid is absorbed by the sorptiocaloric material to induce a phase transition. Preferably the phase transition has some first order character and even more preferably the phase transition is a first order phase transition.

Typically, the sorptiocaloric material is solid. Preferably, the sorptiocaloric material is porous. In some embodiments the sorptiocaloric material comprises a crystalline framework, such as a porous crystalline framework. The sorptiocaloric material may comprise a nanoporous crystalline structure. In this way the sorptiocaloric material may form host-guest interactions with the fluid to induce a phase transition in the sorptiocaloric material.

In some embodiments, the sorptiocaloric material is an open framework material. Open framework materials are porous crystalline structures and may transition between structural phases. Examples of open framework materials include metal-organic frameworks and covalent-organic frameworks. In this way the sorptiocaloric material is able to undergo a phase transition between an narrow pore structure and a large pore structure that is induced by absorption or desorption of a fluid.

The sorptiocaloric material may comprise pores with a diameter of 0.1 nm or more, such as 0.2 nm or more, such as 0.5 nm or more, such as 0.7 nm or more, such as 0.9 nm or more, such as 1.0 nm or more, such as 1.5 nm or more, such as 2 nm or more, such as 2.5 nm or more, such as 3.0 nm or more, such as 3.5 nm or more, such as 4 nm or mor. The sorptiocaloric material may comprise pores with a diameter of 10 nm or less, such as 7 nm or less, such as 5 nm or less, such as 4 nm or less, such as 3.5 nm or less, such as 3 nm or less, such as 2.5 nm or less, such as 2.0 nm or less, such as 1.5 nm or less, such as 1.0 nm or less, such as 0.9 nm or less. The sorptiocaloric material may have comprise pores having a diameter in a range with upper and lower limits described above, such as from 0.1 nm to 10 nm, including 0.1 nm to 5 nm, including 0.5 to 1.5 nm.

A pore diameter may be an average pore diameter, such as a median or a mean pore diameter.

The sorptiocaloric material may have a pore volume of 0.1 cm³ g⁻¹ or more, such as 0.5 cm³ g⁻¹ or more, such as 1 cm³ g⁻¹ or more, such as 1.5 cm³ g⁻¹ or more, such as 2 cm³ g⁻¹ or more. The sorptiocaloric material may have a pore volume of 10 cm³ g⁻¹ or less, such as 8 cm³ g⁻¹ or less, such as 5 cm³ g⁻¹ or less, such as 3 cm³ g⁻¹ or less, such as 2.5 cm³ g⁻¹ or less. The sorptiocaloric material may have a pore volume in a range with upper and lower limits as described above, such as from 0.1 cm³ g⁻¹ to 10 cm³ g⁻¹, including 1 cm³ g⁻¹ to 5 cm³ g⁻¹, including 1 cm³ g⁻¹ to 3 cm³ g⁻¹.

Pore diameter or pore volume may be measured by scanning electron microscopy or by quasi-elastic light scattering, such as described in Horcajada et al. Scanning electron microscopy may be carried out at 5 kV voltage, 10 ρA current and a working distance of 810 mm, such as described in Zhang et al.

Pore diameter or pore volume may be measured using an adsorption analyzer, such as a Micromeritics_ASAP 2020 adsorption analyzer or a Quantachrome Autosorb iQ Series automated gas sorption analyzer. Shahrak et al. describe a typical experiment for analysing pore volume by analysis of adsorption and desorption nitrogen isotherms at 77 K.

Suitable sorptiocaloric materials include covalent organic frameworks (COFs), metal organic frameworks (MOFs), hybrid perovskites, zeolites and mixture thereof. These materials are porous and are capable of undergoing a reversible structural transition that can be triggered by the (de)sorption of guest molecules.

Without wishing to be bound by theory it is proposed that sorptiocaloric materials, and in particular porous crystalline materials (e.g. covalent-organic frameworks, metal-organic frameworks, zeolites, and hybrid perovskites), have complex phase diagrams comprises numerous crystalline structures. As a result, sorptiocaloric materials have many useful properties and in particular efficient storage of gases and liquids. It is proposed that these materials can also show large changes in lattice parameters at first-order phase transitions that can be driven using absorption of benign gases such as nitrogen and benign liquids such as water, which may therefore permit driving giant sorptiocaloric transitions in these materials.

Preferably, the sorptiocaloric material is or comprises a metal-organic framework. Examples of suitable MOFs for use as sorptiocaloric materials include those in the:
MIL family, such as MIL-53, including MIL-53(Fe), MIL-53(AI), MIL-53(Cr) and MIL-53(Ga); MIL-47 including MIL-47(V^{IV}); MIL-100 and MIL-101; and
ZIF family, such as ZIF-4 and ZIF-7.

Preferably, the sorptiocaloric material is a MOF in the MIL family such as MIL-53(Fe).

The fluid for use with a MOF is preferably selected from carbon dioxide, water and methane.

In some preferred embodiments:
the sorptiocaloric material is MIL-53(Fe) and the fluid is selected from carbon dioxide, water and methane;
the sorptiocaloric material is MIL-53(Cr) and the fluid is selected from carbon dioxide and methane;
the sorptiocaloric material is MIL-53(AI) and the fluid is selected from water, carbon dioxide and methane, such as where the fluid is selected from water and methane;
the sorptiocaloric material is MIL-53(Ga) and the fluid is water; or
the sorptiocaloric material is MIL-101 or MIL-100 and the fluid is carbon dioxide.

The term metal-organic frameworks (“MOFs”) refers to a class of compounds that have metal ions or clusters coordinated to organic ligands to form one-, two-, or three-dimensional structures.

The initialism “MIL” as used herein (MIL=Materials of Institut Lavoisier) refers to a class of MOFs which share the features of trivalent metal cations in nodes linked by carboxylate ligands. The materials were first produced at Institut Lavoisier and are known to be relatively highly flexible.

“MIL-53” refers to a specific type of MIL MOF. The MIL-53 structure consists of inorganic [M-OH]chains, which are connected to four neighbouring inorganic chains by terephthalate-based linker molecules. Each metal centre is octahedrally coordinated by six oxygen atoms. Four of these oxygen atoms originate from four different carboxylate groups and the remaining two oxygen atoms belong to two different p-OH moieties, which bridge neighbouring metal centres. The resulting framework structure contains one-dimensional diamond-shaped pores. The term “MIL-53(Fe)” for example refers to a MIL-53 MOF where the metal is iron (Fe).

The initialism “ZIF” as used herein (ZIF=zeolitic imidazolate frameworks) refers to a class of MOFs having tetrahedrally-coordinated transition metal ions that are connected by imidazolate linkers. Examples include ZIF-4 and ZIF-7.

In preferred embodiments the sorptiocaloric material is selected from MIL-53(Fe) and ZIF-4(Zn). More preferably, the sorptiocaloric material is MIL-53(Fe).

The sorptiocaloric material may be or may comprise a covalent-organic framework. Preferred examples include COF-1, COF-5, COF-6, COF-8 and COF-10. Preferably, the fluid for use with these sorptiocaloric materials is carbon dioxide.

The term covalent-organic frameworks (“COFs”) refers to a class of compounds that have two- or three-dimensional structures formed through reactions between organic precursors. COFs are crystalline porous organic polymers that have highly ordered structures. “COF-1” for example refers to a specific type of COF. The COF-1 structure includes rigid two-dimensional layers composed of benzene and B₃O₃ rings and weak van der Waals bonding between the layers. COF-5 has a boronate-ester linked 2D structure that is formed from 2,3,6,7,10,11-hexahydroxytriphenylene and 1,4-phenylene bis(boronic acid) monomers. COF-6, COF-8 and COF-10 are formed by co-condensation reactions between 2,3,6,7,10,11-hexahydroxytriphenylene (HHTP) and 1,3,5-benzenetriboronic acid (BTBA), 1,3,5-benzenetris(4-phenylboronic acid) (BTPA), and 4,4′-biphenyldiboronic acid (BPDA), respectively.

Preferably, the sorptiocaloric material is selected from a COF and a MOF, and more preferably the sorptiocaloric material is selected from a COF and a MOF in the MIL family, such as MIL-53, such as MIL-53(Fe).

The term zeolite refers to a class of porous aluminosilicate minerals having tetrahedral, three-dimensional crystalline structures. An example is merlinoite.

In some embodiments, the sorptiocaloric material comprises a hybrid material such as an organic-inorganic hybrid material for example a metal organics framework. An organic-inorganic hybrid material refers to materials that comprise metal ions or clusters and one or more organic ligands.

A sorptiocaloric material for use according to the present invention may display a conventional caloric effect in response to contact with a fluid, or may display an inverse caloric effect. The same preferences apply equally to the sorptiocaloric processes and materials described herein.

References to the properties of the sorptiocaloric materials are generally made with respect to those displaying conventional caloric effects. However, these references may be construed as references to materials displaying inverse effects, with the skilled person understanding the behaviour of those materials being opposite to those of conventional materials.

A sorptiocaloric material for use in the present invention may be a material having a reversible phase transition at a temperature in the range of 10 K to 500 K, 50 K to 500 K, 100 K to 450 K, such as 200 K to 450 K, such as at ambient pressure, such as at 101.3 kPa.

A phase transition may be a structural phase transition. Examples include breathing transitions involving the displacement of framework atoms between narrow-pore (np) and large-pore (Ip) forms, and swelling transitions which yield gradual enlargement of the framework while usually retaining unit cell shape and space group. Preferably, the sorptiocaloric materials of the present invention includes porous crystalline frameworks that have a phase transition between a narrow-pore (np) and large-pore (Ip) forms.

Typically, a phase transition in the sorptiocaloric material is reversible. An irreversible phase change cannot be used for cooling or heating cycles and is therefore not suitable for cooling or heating applications.

Preferably, the phase transition is a first order phase transition. Without wishing to be bound by theory, an ideal first-order phase transition is a transition in which the molar Gibbs energies or molar Helmholtz energies of the two phases (or chemical potentials of all components in the two phases) are equal at the transition temperature, but their first derivatives with respect to temperature and pressure (for example, specific enthalpy of transition and specific volume) are discontinuous at the transition point, as for two dissimilar phases that coexist and that can be transformed into one another by a change in a field variable such as pressure, temperature, guest molecule absorption, solvation, or magnetic or electric field.

For example, the sorptiocaloric material may have a reversible phase transition at a temperature of 10 K or more, such as 50 K or more, such as 100 K ore more, such as 150 K or more, such as 200 K or more, such as 210 K or more, such as 220 K or more, such as 230 K or more, such as 240 K or more, such as 245 K or more, such as 250 K or more, such as 260 K or more, such as 270 K or more, such as 280 K or more. The reversible phase transition be at a temperature of 500 K or less, such as 450 K or less, such as 400 K or less, such 390 K or less, such as 380 K or less, such as 370 K or less, such as 360 K or less, such as 350 K or less, such as 340 K or less, such as 330 K or less, such as 320 K or less, such as 315 K or less, such as 310 K or less. The phase transition may be in a range with upper and lower limits described above, for example in the range of 10 K to 500 K such as 50 K to 500 K, such as 100 to 450 K, such as 200 K to 450 K, such as 245 to 340 K, such as 245 to 315 K or 280 to 330 K.

Preferably the phase transition lies at a temperature of 200 K or more, such as 250 K or more.

Most preferably the phase transition lies at a temperature that is close to, or at, ambient temperatures. Thus, as noted above, the reversible phase transition may lie at a temperature in the range 245 to 340 K, such as 245 to 315 K or 280 to 330 K.

A phase transition for a material exhibiting conventional caloric effects may be at a temperature below ambient temperature, such as below 250 K. When the sorptiocaloric material is contacted with a fluid the transition temperature may be shifted to a temperature that lies within the ambient range or above, such as within the range 250 to 340 K, such as 270 to 340 K, such as 280 to 330 K.

A phase transition for a material exhibiting inverse caloric effects may be at a temperature that is above ambient temperature, such as above 350 K. When the sorptiocaloric material is contacted with the fluid the transition temperature may be shifted to a temperature that lies within the ambient range or below, such as within the range 250 to 340 K, such as 270 to 340 K, such as 280 to 330 K.

The temperature given for the transition temperature may refer to the starting temperature for the transition, which may refer to the onset of the transition in a cooling or heating cycle at a constant rate of temperature change.

The sorptiocaloric materials described herein include MIL-53(Fe), which has a reversible first order structural phase transition from a monoclinic structure to a triclinic structure. This phase transition is near 320 K.

A sorptiocaloric material may have a plurality of reversible phase transitions and one or each phase transition may occur at a temperature within the limits given above. Where a sorptiocaloric material has a plurality of reversible phase transitions, the methods of the invention may make use of one or more of these transitions, and typically one of these transitions. The methods of the invention may make use of the transition that lies closest to ambient temperature, such as closest to 270, 280 or 300 K.

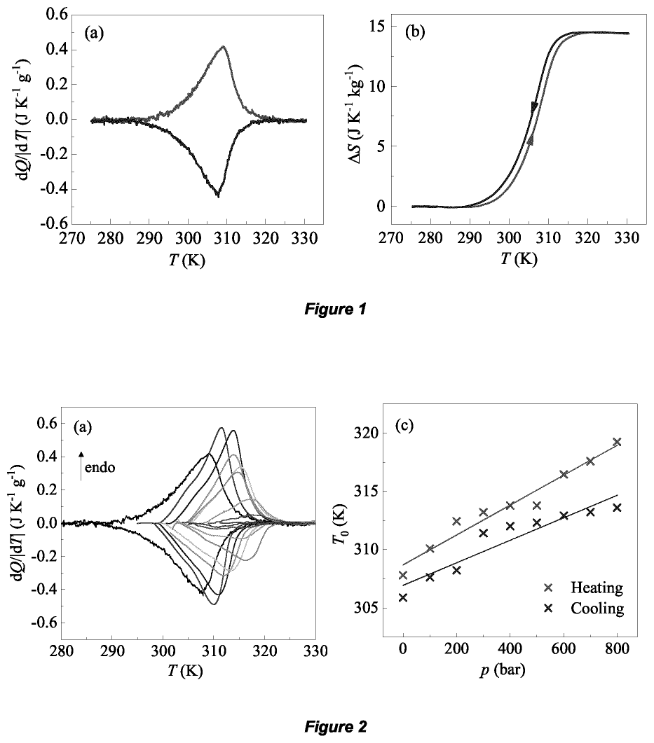

The presence of a phase transition in a sorptiocaloric material may be established from analysis of the heat flow performance of the material across a temperature range including the temperatures mentioned above. For example, the measurements of heat flow may be made by differential scanning calorimetry, such as using a temperature scan rate of 10 K min⁻¹. Lloveras et al., for example, describe a typical experiment for determining the transition temperature at atmospheric pressure (see the Methods section, Calorimetry at Atmospheric Pressure at page 5, together with FIG. 1(b)).

The phase transition temperature may be expressed as the transition temperature observed on heating, cooling, or as the average of the heating and cooling transitions.

A sorptiocaloric material may exhibit an endothermic transition upon heating through the transition point (thus the latent heat Q₀ is >0). It follows then that the sorptiocaloric material will exhibit an exothermic transition upon cooling through the transition point (thus Qₒ is <0).

The entropy change at the transition, |ΔS₀|, may be at least 5 J K⁻¹ kg⁻¹, such as 10 J K⁻¹ kg⁻¹ or more, such as 12 J K⁻¹ kg⁻¹ or more, such as 15 J K⁻¹ kg⁻¹ or more, such as at least 20 J K⁻¹ kg⁻¹ or more, such as 25 J K⁻¹ kg⁻¹ or more, such as 50 J K⁻¹ kg⁻¹ or more, such as 75 J K⁻¹ kg⁻¹ or more, such as 100 J K⁻¹ kg⁻¹ or more, such as 150 J K⁻¹ kg⁻¹ or more, such as 200 J K⁻¹ kg⁻¹ or more, which is the magnitude of the change and this change may be positive or negative as appropriate during heating and cooling through the transition.

The entropy change may refer to the entropy change for the entire transition. Alternatively, where a transition includes a first-order transition optionally with other order transitions, the entropy change may refer to the entropy change for the first-order transition only. Where there is a first-order transition which is a part of the entire transition, the entropy change for the first-order transition may be at least 30%, at least 40% or at least 50% of the entropy change of the entire transition.

The entropy change may be expressed as the entropy change observed on heating, cooling, or as the average of the heating and cooling transitions.

The entropy change at the transition may be determined by differential scanning calorimetry, as described herein.

The phase transition may be accompanied by a change in the unit cell volume of the material, for example the unit cell volume may increase on heating through the phase transition. This is the change observed for conventional caloric materials. A decrease in the unit cell volume may be observed for inverse sorptiocaloric materials.

The volume change at the transition may be 1.0 mm³g⁻¹ or more, such as 5.0 mm³g⁻¹ or more, such as 10 mm³g⁻¹ or more, such as 15 mm³g⁻¹ or more, such as 20 mm³g⁻¹ or more, such as 25 mm³g⁻¹ or more, such as mm³g⁻¹ or more, such as 40 mm³g⁻¹ or more, such as 50 mm³g⁻¹ or more. The volume change at the transition may be a change of 0.1% or more, such as 0.2% or more, such as 0.5% or more, such as 1% or more, such as 2% or more, such as 5% or more, such as 8% or more, such as 10% or more.

The figures given above relate to the magnitude of the change, and this change may be positive or negative as appropriate during heating and cooling through the transition. For example, the volume change may refer to an increase (positive) change in the volume, as such might be observed on heating through the phase transition.

The volume change may refer to the volume change for the entire transition. Alternatively, where a transition includes a first-order transition optionally with other order transitions, the volume change may refer to the volume change for the first-order transition only. Where there is a first-order transition which is a part of the entire transition, the change in volume for the first-order transition may be at least 30%, at least 40% or at least 50% of the volume change for the entire transition.

The change in the volume at the transition may be determined from X-ray diffraction analysis of the sorptiocaloric material during a temperature sweep across the phase transition (where the transition typically occurs across a temperature range). Lloveras et al., for example, describe a typical experiment for determining the volume change at atmospheric pressure (see the Methods section, X-Ray Diffraction at page 5, together with FIG. 1(d)).

The change in the volume at the transition may be determined from volumetric thermal expansion measurements, or from volumetric isothermal compressibility measurements at various temperatures.

The phase transition in the sorptiocaloric material may display a latent heat, |Q₀|, that is 10 kJ kg⁻¹ or more, such as 25 kJ kg⁻¹ or more, such as 50 kJ kg⁻¹ or more, such as 100 kJ kg⁻¹ or more, such as 250 kJ kg⁻¹ or more, such as 500 kJ kg⁻¹ or more. Latent heat values may be determined from the differential scanning calorimetry analysis of the material.

Without wishing to be bound by theory, it is believed that latent Q and ΔS₀ from the structural phase transitions described herein that produces a sorptiocaloric effect in an absorbent-absorbate system is not solely from volume change of the absorbent framework, but includes an interplay of interactions involving bond formation and bond breaking between absorbent and absorbate, and subsequent effects on total bond energies (which includes impact on bond rotation and bond vibrations) in this thermodynamic system as a whole.

### Fluid

The fluid for use in the sorptiocaloric method, apparatus or use of the present invention may be a liquid or a gas.

The fluid may be a guest molecule for absorption within the sorptiocaloric material. The fluid may be contacted with the sorptiocaloric material, in a liquid state or a gas state.

The fluid may be a benign fluid. A benign fluid may be a fluid that is chemically inert. Examples of suitable fluids include water, carbon dioxide, nitrogen hydrogen, and C₁₋₆ alkane.

Preferably, the fluid is water. In these embodiments the sorptiocaloric material may undergo a phase transition that is driven by hydration and/or dehydration, such as by absorption and/or desorption of a water molecule in a pore of the sorptiocaloric material. Water may be contacted with the sorptiocaloric material as a liquid or as a gas.

In preferred embodiments, the fluid is water and the sorptiocaloric material is a hybrid organic-inorganic material, preferably a metal-organic framework, more preferably MIL-53, most preferably MIL-53(Fe).

Contact of the fluid with the sorptiocaloric material may be carried out in the presence of a secondary fluid. The secondary fluid may be a gas such as nitrogen or carbon dioxide. The secondary fluid may be used to apply pressure to the fluid and promote absorption into the sorptiocaloric material.

The fluid may be used to induce the phase transition and as a heat exchange fluid. For example, the apparatus of the invention may be adapted to allow the fluid to flow through a heat exchanger after desorption to extract heat from the fluid. Similarly, the method of the invention may comprise the addition step of flowing the fluid through a heat exchanger after desorption to extract heat from the fluid. In such cases, the fluid is preferably water. In this way, the method, use and apparatus of the invention is more efficient.

The fluid may be used to induce the phase transition and as a heat storage fluid. For example, the apparatus of the invention may be adapted to allow storage and/or transportation of heat in the fluid after desorption. In such cases, the fluid is preferably carbon dioxide. In this way, the method, use and apparatus of the invention is more efficient.

In some embodiments the method of the invention may be a method of thermal energy storage and possibly transport. In such cases, the combination of absorbed fluid and sorptiocaloric material after step (ii) can be used for thermal energy storage.

### Methods and Uses

The present invention provides a method of cooling which uses the fluid-driven caloric effects of the sorptiocaloric materials described herein. Thus, the sorptiocaloric materials find use as cooling agents, for example within a cooling apparatus. The sorptiocaloric materials may be referred to as a refrigerant.

The methods of the invention make use of the change in the thermal behaviour of a sorptiocaloric material in response to contact with a fluid. The absorption/desorption of the fluid to the sorptiocaloric material induces a phase transition. The caloric effect may be advantageously used within a heat pump cycle or a refrigeration cycle to provide heating or cooling respectively.

The methods of the invention allow for the use of sorptiocaloric materials displaying conventional caloric effects as well as inverse caloric effects.

A method of caloric cooling or heating may comprise the steps of:
(i) providing a sorptiocaloric material;
(ii) contacting the sorptiocaloric material with a fluid such that the fluid is absorbed into and at least partially throughout the sorptiocaloric material to induce a phase transition;
(iii) permitting heat flow from or to the sorptiocaloric material;

By contacting the sorptiocaloric material with a fluid, a phase transition is induced, such as a structural phase transition, which is accompanied by a change in volume.

The fluid may be absorbed in an amount of 10 cm³ g⁻¹ or more, such as 50 cm³ g⁻¹, such as 100 cm³ g⁻¹ or more, such as 150 cm³ g⁻¹ or more, such as 200 cm³ g⁻¹ or more, such as such as 220 cm³ g⁻¹ or more, such as 250 cm³ g⁻¹ or more, such as 260 cm³ g⁻¹ or more. The fluid may be absorbed in an amount of 800 cm³ g⁻¹ or less, such as 600 cm³ g⁻¹ or less, such as 500 cm³ g⁻¹ or less, such as 400 cm³ g⁻¹ or less, such as 300 cm³ g⁻¹ or less. The fluid may be absorbed in an amount with upper and lower limits as described above, such as from 10 to 800 cm³ g⁻¹, including 50 to 500 cm³ g⁻¹.

The amount of fluid absorbed may be measured by a method using an absorption apparatus, such as a Micromeritics_ASAP 2020 adsorption apparatus or a Quantachrome Autosorb iQ Series automated gas sorption analyzer. Measurements may be carried out at a pressure of up to 0.107 MPa and a temperature such as 77 K, 273 K, 298 K or 323 K. Shahrak et al., for example, describe a typical experiment for measuring the absorption of a fluid such as carbon dioxide at a pressure up to 800 mm Hg (0.107 MPa) and an initial degassing process was carried out at 150° C. for 12 h under a 0.0001 mm Hg (0.013 Pa) vacuum pressure. Zhang et al. describe a typical experiment for nitrogen sorption isotherms are measured at 77 K. Llewellyn et al. describe a typical experiment where adsorption of carbon dioxide or methane are measured, where experiments were carried out 303 K and after outgassing under vacuum to a final temperature of 423 K.

The amount of fluid absorbed described herein may be a STP (standard temperature and pressure; 273 K and 105 Pa) gas volume.

The method of the invention may be performed at a temperature from 10K to 500 K, such as from 50 K to 500 K, such as from 200 K to 450 K, such as 200 K to 400 K, such as 350 K to 400K, such as 270 K to 340 K, such as 275 K to 340 K, such as 280 K to 310 K, such as 280 K to 305 K. Preferably, the method is performed around ambient temperature, such as around 298 K or around 300 K.

The methods of the invention may include applying a pressurising force to contact the sorptiocaloric material with the fluid in step (ii), such as to absorb a guest molecule of the fluid to the sorptiocaloric material.

In some embodiments, a pressuring force of 500 MPa or less is applied, such as 200 MPa or less, such as 100 MPa or less, such as 50 MPa or less, such as 25 MPa or less, such as 20 MPa or less, such as 10 MPa or less, such as 8 MPa or less, such as 5 MPa or less, such as 1 MPa or less. A pressuring force of 0.01 MPa or more may be applied, such as 0.05 MPa or more, such as 0.1 MPa or more, such as 0.5 MPa or more, such as 1 MPa or more, such as 5 MPa or more. The pressure applied may be in a range with upper and lower limits described above, such as from 0.01 MPa to 500 MPa, including 0.5 MPa to 100 MPa, including 5 MPa to 50 MPa.

Preferably, a pressuring force of 10 MPa or less is applied, such as between 1 to 10 MPa.

The pressure applied may be a hydrostatic pressure.

The application of hydrostatic pressure may be achieved by applying water to the fluid that is absorbed by the sorptiocaloric material. In such cases, the fluid itself may be water.

The application of hydrostatic pressure may be achieved by applying pressure to the sorptiocaloric material contained within a pressure-transmitting medium.

Pressure-transmitting media are known in the art and include liquid and solid materials. The pressure-transmitting medium may be the same as the fluid that is absorbed by the sorptiocaloric material, or the pressure-transmitting medium may be different from the fluid that is absorbed by the sorptiocaloric material.

An example of a pressure-transmitting liquid includes alkoxy silane materials, such as DW-Therm, available from Huber Kaltemaschinenbau GmbH. An example of a pressure-transmitting solid is alumina powder.

Pressure may be applied near the transition temperature of the sorptiocaloric material. For example, the pressure may be applied at a temperature that is within 50 K, such as within 20 K, such as within 15 K, such as within 10 K, such as within 5 K, such as within 2 K, such as within 1 K, such as within 0.5 K of the transition temperature.

In some embodiments, the fluid that is absorbed within the sorptiocaloric material is water. In these embodiments, hydrostatic pressure may be applied to contact the water with the sorptiocaloric material such that a water molecule is absorbed into the sorptiocaloric material. The fluid may be contacted with the sorptiocaloric material in the presence of a secondary fluid, which may be for promoting absorption. The fluid may be contacted with a sorptiocaloric material in a nitrogen atmosphere. The nitrogen atmosphere may be pressurised/depressurised to promote the absorption/desorption process.

The method may further comprise the steps of:
(iv) releasing the fluid such that the fluid is desorbed out of the sorptiocaloric material and the reverse structural phase transition is induced; and
(v) permitting heat flow to or from the sorptiocaloric material.

The method may thus form a complete heat and cool cycle.

Steps (iv) and (v) may be carried out immediately after steps (i) to (iii). Steps (iv) and (v) may be carried out later for example, after the sorptiocaloric material has been transported. This allows the process of the invention to be used for heat transfer between different sites.

Steps (i) to (v) are preferably performed in order.

In the methods of the invention the sorptiocaloric material may be used with a heat transfer fluid to and from which heat may be transferred. The heat transfer fluid is typically a liquid. The heat transfer fluid may transfer heat to the sorptiocaloric material, thereby resulting in the relative cooling of the heat transfer fluid. The cooled heat transfer fluid may then be taken from the sorptiocaloric material and delivered to a location where cooling is desired.

A heat transfer fluid may accept heat transfer from the sorptiocaloric material, thereby resulting in the relative cooling of the sorptiocaloric material. The heated heat transfer fluid may then be taken from the sorptiocaloric material and delivered to a location for cooling, such as a radiator or another such heat exchanger, for example for cooling to ambient temperature.

A heat transfer fluid may be different from the fluid that is absorbed by the sorptiocaloric material, or these fluids may be the same. Preferably, the fluid that is contacted with the sorptiocaloric material in step (ii) may itself be used as the heat transfer fluid. In these embodiments the fluid is preferably water or carbon dioxide.

It is not necessary for the heat transfer fluid to directly contact the sorptiocaloric material, and the heat transfer may occur via a heat exchanger. A heat exchanger may use a heat switch, such as a thermoelectric heat switch, an electromechanical heat switch, a solid-state thermal diode or a heat pipe. The use of compact switches of these types may improve the design of the cooling devices, and enhance their energy efficiency.

In the methods of the invention the sorptiocaloric material and the fluid may be used for storage of heat that is generated by a sorptiocaloric effect. For example, the fluid may be absorbed into the sorptiocaloric material (step (ii)) and store thermal energy which can be released at a chosen time and location in step (iv).

In some embodiments, the method comprises a step of storing the heat in a heat storage fluid between steps (iii) and (iv).

A heat storage fluid may be different from the fluid that is absorbed by the sorptiocaloric material, or these fluids may be the same. Preferably, the fluid that is contacted with the sorptiocaloric material in step (ii) may itself be used as the heat storage fluid. Heat is released from the fluid when pressure is released, for example, so these fluids can be used for pressure-controlled storage devices that do not display energy losses. This is particularly useful for transport of heat over long distances. In these embodiments the fluid is preferably carbon dioxide.

The sorptiocaloric material may also be used together with a regenerator in order to alter or increase the temperature range of operation. The sorptiocaloric material may itself be used as a regenerator.

The caloric effects observed with the sorptiocaloric materials can be achieved at relatively low pressures, which may be lower than typical barocaloric effects.

The methods of the invention may be for use in one or more of:
cooling foodstuffs or beverages;
cooling medicines;
cooling biological samples, such as tissues;
cooling electronic devices, such as devices for analytical measurements; and
cooling air, such as air within a building or a vehicle.

Also provided herein is use of a sorptiocaloric material as a cooling or heating material, wherein the use comprises contacting the sorptiocaloric material with a fluid such that the fluid is absorbed into and throughout the sorptiocaloric material to induce a phase transition. Contacting the sorptiocaloric material with the fluid induces a phase transition of the sorptiocaloric material, such as a reversible phase transition, such as a reversible first-order phase transition. The preferences and features described for the method of the invention apply equally to the use of a sorptiocaloric material as a cooling or heating material.

### Cooling or Heating Apparatus

The invention provides a cooling or heating apparatus containing a sorptiocaloric material as described herein. The cooling or heating apparatus is adapted to provide caloric cooling or heating using the sorptiocaloric material.

The cooling or heating apparatus comprises the sorptiocaloric material and means for reversibly contacting the sorptiocaloric material with the fluid such that the fluid is absorbed by the sorptiocaloric material to induce a phase transition. Typically, a cooling or heating apparatus further comprises means for transferring heat to and from the sorptiocaloric material. The means may be a heat transmitting fluid which may be the fluid being absorbed to the sorptiocaloric material or may be a different heat transmitting fluid.

The sorptiocaloric material may undergo a phase transition that is induced by absorption or desorption of a guest molecule. Absorption or desorption may be under applied pressure. Thus, the cooling or heating apparatus may further comprise means for applying pressure, such as hydrostatic pressure to the sorptiocaloric material.

The cooling apparatus may be for use in cooling foodstuffs and beverages, thus the cooling apparatus may be a component of a refrigerator or a freezer. The cooling apparatus may find general use in cooling air, thus the cooling apparatus may be a component of an air-conditioning unit.

In other aspects of the invention there is more generally provided a heat engine for the transfer of heat between environments, where the heat engine has a sorptiocaloric material as described herein.

Whilst the predominant use of refrigerants is in refrigerators and air-conditioning units, the principles underlying the mechanism of cooling an environment may also be used to heat an indoor environment, for example within an air-source heat pump. Here, a cool sorptiocaloric material in a first phase may be warmed by the outside ambient environment (including indirectly via a heat transfer fluid). The warmed sorptiocaloric material may then be taken to a second phase, with an associated heat transfer from the environment to the sorptiocaloric material (including indirectly via a heat transfer fluid). The sorptiocaloric material is then returned to the indoor environment, where it is permitted to return to the first phase, with an associated heat transfer from the sorptiocaloric material to the indoor environment. There may be intermediate stages between the first and second phase.

### Other Embodiments

Each and every compatible combination of the embodiments described above is explicitly disclosed herein, as if each and every combination was individually and explicitly recited. Various further aspects and embodiments of the present invention will be apparent to those skilled in the art in view of the present disclosure.

“and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

Unless context dictates otherwise, the descriptions and definitions of the features set out above are not limited to any particular aspect or embodiment of the invention and apply equally to all aspects and embodiments which are described.

Certain aspects and embodiments of the invention will now be illustrated by way of example and with reference to the figures described above.

### Examples

A number of example systems were prepared and tested.

### Materials

The materials used in the examples were prepared according to the procedures below.

### Synthesis of MIL-53(Fe)

0.541 g of iron (III) chloride hexahydrate (FeCl3·6H2O) and 0.334 g terephthalic acid were added to 10 mL DMF (1:1:65 molar ratio) in a small glass beaker and swirled until the solid dissolved. The solution was then transferred to a 23 ml parr acid digestion bomb and placed in a Heraeus heating oven at 423 K for 72 h and then cooled to room temperature. The orange powder was then collected by vacuum filtration, washed thrice with ˜3 ml DMF and placed in a vacuum oven at 423 K overnight to obtain desolvated MIL-53 (Fe).

### Synthesis of ZIF-4

1.202 g of zinc (II) nitrate hexahydrate and 0.909 g of imidazole were added to 90 mL DMF in a glass bottle and swirled until the solid contents dissolved (4:13:860 molar ratio as carried out by Wharmby et. al.). The bottle was placed in a Heraeus heating oven at 373 K for 72 h and then taken out and cooled to room temperature. Vacuum filtration was used to obtain white ZIF-4 powder, which was subsequently washed with 3 ml DMF thrice and dried in air for 24 h. The filtrate was poured back into the glass bottle and replaced back in the oven two more times, followed by the vacuum filtration process each time to obtain more sample. ZIF-4(DS) was obtained by placing the pristine ZIF-4-as sample in a vacuum oven at 423 K for 5 hours.

### Synthesis of ZIF-7

1.602 g of zinc nitrate hexahydrate (Zn(NO3)2·6H2O) and 0.471 g of benzimidazole were dissolved in 150 mL of DMF under magnetic stirring (4:5:2000 molar ratio as described by Wu et. al. [ref. 79]). The solution was then transferred in to two sealed 100 mL Teflon autoclaves and heated at 403 K for 48 h. Vacuum filtration was used to obtain pale white ZIF-7 crystals, which were subsequently washed with 3 ml DMF thrice and dried in air before being capped in a glass vial.

### Synthesis of MIL-53(AI)

1.309 g of aluminium (III) nitrate nonahydrate (Al(NO3)3□9H2O) and 0.287 g of terephthalic acid were added to 8.7 ml of deionised water (2:1:160 molar ratio as reported by Loiseau et. al.) and stirred until the solid dissolved. The solution was then transferred to a 23 ml parr acid digestion bomb and heat at 493 K for 72 h and then cooled to room temperature. The white powder was vacuum filtered and washed thrice with deionised water and placed in an oven at 573 K for 2 hours to ensure evacuation of excess terephthalic acid molecules from pores. X-ray diffraction was performed on the sample 16 hours later.

### Methods

The following method were used in the examples.

### Differential Scanning Calorimetry (DSC)

DSC measurements were performed on all samples using a Q2000 ambient-pressure DSC from TA Instruments, with a working temperature range of 123 to 673 K, using the heat-flux DSC method with linear temperature ramping. A liquid nitrogen cooling system was used when cooling the sample chamber below room temperature. Samples of MOF weighing between 5-20 mg or polymer hydrogel weighing between 25-32 mg was placed on an aluminium crucible and hermetically sealed to prevent loss of solvent or water during the run. It was then inserted into the DSC autosampler along with an empty, hermetically sealed aluminium crucible as a reference, which the autosampler transfers into the thermally isolated sample chamber for measurements.

Heat flow measurements were used for entropy change calculations as opposed to heat capacity measurements since much more detailed analysis would be required to obtain accurate heat capacity values for each sample by carrying out multiple runs with a calibration sample of known heat capacity, such as indium or sapphire, before and after each sample run when using conventional measurements.

### Sorptiocaloric Effects in MIL-53(Fe)

This example investigates MIL-53(Fe) and evaluates thermally driven entropy changes at zero field of this material, which is a good indicator for how well they can perform as sorptiocaloric materials. MOFs were synthesized using solvothermal or hydrothermal techniques which require a metal salt and organic ligand source dissolved in a solvent or in water, respectively.

Metal-organic frameworks are materials that consist of hybrid structures built using metal ions or clusters and organic ligands. The combination of these two dissimilar components offers scope for different structural designs, with the benefit of great tunability of the corresponding dimensionality and topology, which are key for the sorption properties of fluids of these materials systems. This diversity of structures enables tailoring properties such as density, degree of porosity, electric properties, and magnetic properties. In particular, some of these hybrid materials can achieve large degrees of porosity, and can display very large values of surface area to mass ratios (˜6,000 m²/g). As a result, a number of metal-organic frameworks have been reported to be extremely efficient gas sorbents, for example for harmless nitrogen gas, CO₂ or water, either by adsorption of molecules at the surface, or by absorption within the bulk of the material, which are labelled collectively as sorption processes, and involve the formation or breaking of chemical bonds or Van der Waals interactions.

These sorption capabilities are one of the aspects of the dynamic nature of metal-organic frameworks under external stimuli. In addition to flexibilities exhibited under changes in temperature and pressure, these porous materials are associated with reversible structural transitions triggered by the sorption of guest molecules. This includes breathing transitions which involve the displacement of framework atoms between narrow-pore (np) and large-pore (Ip) forms induced by sorption and thermomechanical stimuli, and swelling transitions which yield gradual enlargement of the framework upon absorption while usually retaining unit cell shape and space group. Such transitions are therefore accompanied by volume changes in the metal-organic framework, which stem from the formation of intermolecular bonds between absorbate and framework molecules at the pore walls, which are commonly hydrogen bonds (H-bonds) that lead to physisorption.

Certain types of metal-organic frameworks, which are grouped into families based on common features such as structural similarities, are known to demonstrate characteristic framework flexibilities. Thermal properties of selected MOFs are shown in Table 1.

The MIL family (MIL=Materials of Institut Lavoisier) constitutes trivalent metal cations in nodes linked by carboxylate ligands, producing porous frameworks that exhibit exemplary flexibility. In particular, the MIL-53 group, consisting of nodes octahedrally coordinated by terephthalates (1,4 benzenedicarboxylates), is well-known for demonstrating the breathing mode of flexibility, while the MIL-88 group, with trimers of nodes connected by ligands forming trigonal bipyramidal cages, displays swelling (Mellot-Draznieks et al.).

Zeolitic imidazolate frameworks (ZIFs) are another family of metal-organic frameworks known for having dynamic structures. Isostructural to zeolites, ZIFs are composed of transition metal ions tetrahedrally coordinated to imidazolate ligands, where the metal imidazolate metal angle lies at 1450, analogous to the Si O Si angle in zeolites. In addition to exhibiting breathing transitions (Henke et al., Gandara-Loe et al.), many ZIFs are known to undergo reconstructive and displacive phase transitions due to linker rotations triggered by changes in temperature, pressure and sorption (Ryder et al.), which have the potential to lead to large volume and entropy changes (Wharmby et al.).

TABLE 1
Selected metal-organic frameworks (MOFs) with different types
of reversible phase transitions at temperatures T₀. Values of thermally
driven ΔS₀ and volume changes are given.

| | | T₀ | \|ΔS₀\| | \|ΔV₀/V₀\| | \|Δv₀\| |
|---|---|---|---|---|---|
| MOF | Transition type | (K) | (J K⁻¹ kg⁻¹) | % | cm³ kg⁻¹ |
| ZIF-4 | LT-HT | 145 | ~150 | 23 | 189 |
| (Zn) | N₂ breathing | 77 | ~26 | 9 | 66 |
| | (0.3 bar) | | | | |
| MIL- | (de)hydration | 310 | N/R | 9.6 | 55 |
| 53(Fe) | | | | | |
| ZIF-7 | (de)solvation | 350 | ~22 | 10 | 81 |
| | CO₂ breathing | 320 | ~100 | 2.3 | 19 |
| | (5 bar) | | | | |

First, dehydration of the low-temperature hydrated MIL-53(Fe)-It structure [monoclinic (C2/c)] on heating at T₀˜313 K converts the structure to an intermediate triclinic (P1) anhydrous phase, MIL-53(Fe)-int, during which the volume decreases by ˜94 Å (9.6%). Further heating to T₀˜423 K produces the stable anhydrous high-temperature MIL-53(Fe)-ht structure, following a slight increase in unit cell volume by 0.8%. However, since the intermediate phase is still fully dehydrated, the lower T₀ and relatively large volume change from the It↔int transition is used to probe caloric effects near this sorption-driven phase transition in MIL-53(Fe).

A transition of particular interest in MIL-53(Fe) is the dehydration/hydration-induced structural transition, which occurs at ˜320 K. This transition was first evaluated by calorimetry at ambient pressure using the TA Q2000, with the hydrated MIL-53(Fe)-It powder sealed in a hermetic sample holder, at |dT/dt|=2 K min⁻¹, during which heat flow peaks from a first-order transition are clearly be observed on heating and cooling (FIG. 1).

The peaks in FIG. 1 display very low hysteresis (˜1.5 K) and indicate that the dehydration/hydration process in MIL-53(Fe) induces a transition at T₀˜308 K spanning ˜30 K, with a |ΔS₀|˜14.4 J K⁻¹ kg⁻¹.

The Clausius-Clapeyron relationship relating volume and pressure is not applicable in this example because the phase transition involving the volume change in the MIL-53(Fe) framework is not directly induced by change in pressure, but by sorption and desorption of guest molecules (i.e. water) in the thermodynamic system.

Since the high-temperature phase of MIL-53(Fe) has a smaller volume (ΔV₀/V=−9.6% on heating), the dehydrated phase should be stabilised under higher applied p, yielding an inverse caloric effect. However, the results clearly indicate a conventional caloric effect, since dT₀/dp>0. The hydrated phase is stabilised at higher p, despite being larger in volume than the dehydrated phase. This suggests that the free energy of the hydrated system is lower at higher pressures, which is likely due to enthalpic stabilisation, a phenomenon often observed in MOFs, and demonstrates that the transition is driven by the absorption and desorption of water molecules.

Further, hydration induces an increase in unit cell volume by up to ΔV₀/V=10.6% in the MIL-53(Fe) framework. If the Clausius-Clapeyron relation was used to estimate dT₀/dp using this ΔV₀/V value, along with the bulk density ρ˜1.06 g cm⁻³ of the dehydrated phase and the initial thermally-driven |ΔS₀|˜14.4 J K⁻¹ kg⁻¹ associated with the dehydration-hydration transition, a |dT₀/dp|˜694 K kbar⁻¹ would be calculated, which is unrealistically high and in contradiction with the experimental data (see FIG. 2(b)).

Thus, latent Q and ΔS₀ from this phase transition that produces the sorptiocaloric effect in this absorbent-absorbate system is not solely from volume change of the absorbent framework, but by an interplay of interactions involving bond formation and bond breaking between absorbent and absorbate, and subsequent effects on total bond energies (which includes impact on bond rotation and bond vibrations) in this thermodynamic system as a whole. It is an interplay not between a small-volume phase and large-volume phase, but between an absorbed state and desorbed state. Note that N₂ is required here to assist this effect because the experimental system that uses only water is under construction. Without the presence of the guest molecule (water), no such transition would occur and thereby no caloric effect would be produced despite changes in pressure, cf. samples without water show no transition.

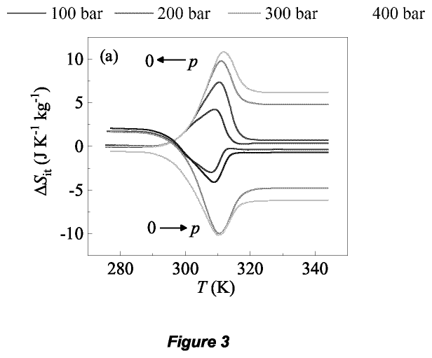

FIG. 3 shows the sorptiocaloric effects displayed by this material, which are highly reversible due to the small hysteresis of the dehydration/hydration transition.

### REFERENCES

A number of publications are cited above in order to more fully describe and disclose the invention and the state of the art to which the invention pertains. Full citations for these references are provided below. The entirety of each of these references is incorporated herein.
Boldrin, Appl. Phys. Lett. 119, 2021
Gandara-Loe et al., J. Mater. Chem. A 7(24), 2019
Horcajada et al., Nat. Mater. 9(2), 2010
Henke et al., Chem. Sci. 9(6), 2018
Llewellyn et al., Langmuir 24(14), 2008
Lloveras et al. Nature Commun. 2015, 6, Article no. 8801
Mellot-Draznieks et al., J. Am. Chem. Soc. 127(46), 2005
Ryder et al., Phys. Rev. Lett. 113(21), 2014
Shahrak et al., Chin. J. Chem. Eng. 25(5), 2017
Wharmby et al., Angew. Chem. Int. Ed. 54(22), 2015
Zhang et al., Sci. Rep. 4, 2014

1. A method of caloric cooling or heating, the method comprising the steps of:
(i) providing a sorptiocaloric material;
(ii) contacting the sorptiocaloric material with a fluid such that the fluid is absorbed into and at least partially throughout the sorptiocaloric material to induce a phase transition;
(iii) permitting heat flow from or to the sorptiocaloric material;
(iv) releasing the fluid such that the fluid is desorbed out of the sorptiocaloric material and the reverse phase transition is induced; and
(v) permitting heat flow to or from the sorptiocaloric material.

2-3. (canceled)

4. The method of claim 1,
wherein the sorptiocaloric material is porous, optionally
wherein the sorptiocaloric material comprises pores having a diameter in the range of 0.1 to 5 nm, such as from 0.5 to 1.5 nm; and/or
wherein the sorptiocaloric material has a pore volume from 0.1 cm³ g⁻¹ to 10 cm³ g⁻¹, such as from 1 cm³ g⁻¹ to 5 cm³ g⁻¹ or from 1 cm³ g⁻¹ to 3 cm³ g⁻¹.

5-7. (canceled)

8. The method of claim 1, wherein the sorptiocaloric material is a crystalline framework, such as a porous crystalline framework, such as wherein the crystalline framework is an open framework material.

9. (canceled)

10. The method of claim 1, wherein the sorptiocaloric material is a metal organic framework, optionally
wherein the sorptiocaloric material is a metal organic framework in the MIL family, such as MIL-53, such as MIL-53(Fe); optionally
wherein the metal organic framework is a MIL family or ZIF family metal organic framework such as MIL-53, including MIL-53(Fe), MIL-53(Al), MIL-53(Cr) and MIL-53(Ga) or MIL-47 including MIL-47(V^{IV}); MIL-100 and MIL-101; or ZIF-4 and ZIF-7, preferably, the sorptiocaloric material is a MIL family metal organic framework such as MIL-53(Fe); optionally
wherein the fluid is selected from carbon dioxide, water and methane; optionally
wherein the fluid is a benign fluid, optionally selected from nitrogen, carbon dioxide and water; optionally
wherein the fluid comprises water.

11-13. (canceled)

14. The method of claim 1, wherein the sorptiocaloric material is a covalent organic framework, optionally
wherein the sorptiocaloric material is a covalent-organic framework selected from COF-1, COF-5, COF-6, COF-8 and COF-10; and/or
wherein the fluid is carbo dioxide; optionally
wherein the fluid is a benign fluid, optionally selected from nitrogen, carbon dioxide and water; optionally
wherein the fluid comprises water.

15-18. (canceled)

19. The method according to claim 1, wherein the fluid further provides heat transfer to and from the sorptiocaloric material; and/or
wherein the sorptiocaloric material with fluid absorbed therein is used for thermal storage.

20. The method of claim 1, wherein a phase transition in the sorptiocaloric material displays a latent heat, |Q₀|, that is 10 kJ kg⁻¹ or more, such as 25 kJ kg⁻¹ or more, such as 50 kJ kg⁻¹ or more, such as 100 kJ kg⁻¹ or more, such as 250 kJ kg⁻¹ or more, such as 500 kJ kg⁻¹ or more; and/or
wherein the sorptiocaloric material has an entropy change at a phase transition, |ΔS₀|, of 5 J K⁻¹ kg⁻¹ or more, such as 10 J K⁻¹ kg⁻¹ or more, such as 15 J K⁻¹ kg⁻¹ or more; and/or
wherein the sorptiocaloric material has a phase transition at a temperature within the range 200 to 450 K, such as 250 to 350 K, such as 280 to 340 K; and/or
wherein the phase transition of the sorptiocaloric material is a first-order phase transition; and/or
wherein the phase transition of the sorptiocaloric material is a first-order structural phase transition, such as between symmetry groups; and/or
wherein the sorptiocaloric material is contacted with the fluid at a pressure of 500 MPa or less, such as 200 MPa or less, such as 100 MPa or less, such as 50 MPa or less, such as 25 MPa or less, such as 20 MPa or less, such as 10 MPa or less, such as 5 MPa or less; and/or
wherein the fluid is absorbed in an amount of 10 cm³ g⁻¹ or more, such as 50 cm³ g⁻¹ or more, such as from 50-500 cm³ g⁻¹.

21-27. (canceled)

28. A cooling or heating apparatus comprising
a sorptiocaloric material as a cooling or heating agent;
a means for transferring heat to and from the sorptiocaloric material; and
a means for reversibly contacting the sorptiocaloric material with a fluid such that the fluid is absorbed into the sorptiocaloric material.

29. The apparatus of claim 28, wherein the sorptiocaloric material is porous, optionally
wherein the sorptiocaloric material comprises pores having a diameter in the range of 0.1 to 5 nm, such as from 0.5 to 1.5 nm; and/or
wherein the sorptiocaloric material has a pore volume from 0.1 cm³ g⁻¹ to 10 cm³ g⁻¹, such as from 1 cm³ g⁻¹ to 5 cm³ g⁻¹ or from 1 cm³ g⁻¹ to 3 cm³ g⁻¹.

30. The apparatus of claim 28, wherein the sorptiocaloric material is a crystalline framework, such as a porous crystalline framework, such as wherein the crystalline framework is an open framework material.

31. The apparatus of claim 28, wherein the sorptiocaloric material is a metal organic framework, optionally
wherein the sorptiocaloric material is a metal organic framework in the MIL family, such as MIL-53, such as MIL-53(Fe); optionally
wherein the metal organic framework is a MIL family or ZIF family metal organic framework such as MIL-53, including MIL-53(Fe), MIL-53(Al), MIL-53(Cr) and MIL-53(Ga) or MIL-47 including MIL-47(V^{IV}); MIL-100 and MIL-101; or ZIF-4 and ZIF-7, preferably, the sorptiocaloric material is a MIL family metal organic framework such as MIL-53(Fe); optionally.
wherein the fluid is selected from carbon dioxide, water and methane.

32. The apparatus of claim 28, wherein the sorptiocaloric material is a covalent organic framework, optionally
wherein the sorptiocaloric material is a covalent-organic framework selected from COF-1, COF-5, COF-6, COF-8 and COF-10; and/or
wherein the fluid is a benign fluid, optionally selected from nitrogen, carbon dioxide and water; optionally
wherein the fluid is carbon dioxide; optionally.
wherein the fluid comprises water.

33. The apparatus of claim 28, wherein a phase transition in the sorptiocaloric material displays a latent heat, |Q₀|, that is 10 kJ kg⁻¹ or more, such as 25 kJ kg⁻¹ or more, such as 50 kJ kg⁻¹ or more, such as 100 kJ kg⁻¹ or more, such as 250 kJ kg⁻¹ or more, such as 500 kJ kg⁻¹ or more; and/or
wherein the sorptiocaloric material has an entropy change at a phase transition, |ΔS₀|, of 5 J K⁻¹ kg⁻¹ or more, such as 10 J K⁻¹ kg⁻¹ or more, such as 15 J K⁻¹ kg⁻¹ or more; and/or
wherein the sorptiocaloric material has a phase transition at a temperature within the range 200 to 450 K, such as 250 to 350 K, such as 280 to 340 K; and/or
wherein the phase transition of the sorptiocaloric material is a first-order phase transition; and/or
wherein the phase transition of the sorptiocaloric material is a first-order structural phase transition, such as between symmetry groups; and/or
wherein the fluid is absorbed in an amount of 10 cm³ g⁻¹ or more, such as 50 cm³ g⁻¹ or more, such as from 50-500 cm³ g⁻¹; and/or
wherein the fluid further provides heat transfer to and from the sorptiocaloric material.

34. Use of a sorptiocaloric material as a cooling or heating material, wherein the use comprises contacting the sorptiocaloric material with a fluid such that the fluid is absorbed into and throughout the sorptiocaloric material to induce a phase transition.

35. The use of claim 34, wherein the sorptiocaloric material is porous, optionally
wherein the sorptiocaloric material comprises pores having a diameter in the range of 0.1 to 5 nm, such as from 0.5 to 1.5 nm; and/or
wherein the sorptiocaloric material has a pore volume from 0.1 cm³ g⁻¹ to 10 cm³ g⁻¹, such as from 1 cm³ g⁻¹ to 5 cm³ g⁻¹ or from 1 cm³ g⁻¹ to 3 cm³ g⁻¹.

36. The use of claim 34, wherein the sorptiocaloric material is a crystalline framework, such as a porous crystalline framework, such as wherein the crystalline framework is an open framework material.

37. The use of claim 34, wherein the sorptiocaloric material is a metal organic framework, optionally
wherein the sorptiocaloric material is a metal organic framework in the MIL family, such as MIL-3, such as MIL-53(Fe); optionally
wherein the metal organic framework is a MIL family or ZIF family metal organic framework such as MIL-53, including MIL-53(Fe), MIL-53(Al), MIL-53(Cr) and MIL-53(Ga) or MIL-47 including MIL-47(V^{IV}); MIL-100 and MIL-101; or ZIF-4 and ZIF-7, preferably, the sorptiocaloric material is a MIL family metal organic framework such as MIL-53(Fe); optionally.
wherein the fluid is selected from carbon dioxide, water and methane.

38. The use of claim 34, wherein the sorptiocaloric material is a covalent organic framework, optionally
wherein the sorptiocaloric material is a covalent-organic framework selected from COF-1, COF-5, COF-6, COF-8 and COF-10; and/or
wherein the fluid is a benign fluid, optionally selected from nitrogen, carbon dioxide and water; optionally
wherein the fluid is carbon dioxide; optionally.
wherein the fluid comprises water.

39. The use according to claim 34, wherein the fluid further provides heat transfer to and from the sorptiocaloric material; and/or
wherein the sorptiocaloric material with fluid absorbed therein is used for thermal storage.

40. The use of claim 34, wherein a phase transition in the sorptiocaloric material displays a latent heat, |Q₀|, that is 10 kJ kg⁻¹ or more, such as 25 kJ kg⁻¹ or more, such as 50 kJ kg⁻¹ or more, such as 100 kJ kg⁻¹ or more, such as 250 kJ kg⁻¹ or more, such as 500 kJ kg⁻¹ or more; and/or
wherein the sorptiocaloric material has an entropy change at a phase transition, |ΔS₀|, of 5 J K⁻¹ kg⁻¹ or more, such as 10 J K⁻¹ kg⁻¹ or more, such as 15 J K⁻¹ kg⁻¹ or more; and/or
wherein the sorptiocaloric material has a phase transition at a temperature within the range 200 to 450 K, such as 250 to 350 K, such as 280 to 340 K; and/or
wherein the phase transition of the sorptiocaloric material is a first-order phase transition; and/or
wherein the phase transition of the sorptiocaloric material is a first-order structural phase transition, such as between symmetry groups; and/or
wherein the sorptiocaloric material is contacted with the fluid at a pressure of 500 MPa or less, such as 200 MPa or less, such as 100 MPa or less, such as 50 MPa or less, such as 25 MPa or less, such as 20 MPa or less, such as 10 MPa or less, such as 5 MPa or less; and/or
wherein the fluid is absorbed in an amount of 10 cm³ g⁻¹ or more, such as 50 cm³ g⁻¹ or more, such as from 50-500 cm³ g⁻¹.
